(19) United States
(12) Patent Application Publication
(10) Pub. No.: US 2013/0185113 A1
(43) Pub. Date: Jul. 18, 2013

(54) WELL WORK OPPORTUNITY SYSTEM

(71) Applicant: BP Corporation North America Inc., Houston, TX (US)

(72) Inventors: Randi Jo Culp, Amarillo, TX (US); Jairo Freyre, Houston, TX (US); Perry Jarrell, Houston, TX (US); Gloria Esperanza Lazaro, Houston, TX (US); Mahesh Venugopalan, Sugar Land, TX (US)

(73) Assignee: BP CORPORATION NORTH AMERICA INC., Houston, TX (US)

(21) Appl. No.: 13/712,593

(22) Filed: Dec. 12, 2012

Related U.S. Application Data
(60) Provisional application No. 61/579,100, filed on Dec. 22, 2011.

(51) Int. Cl. G06Q 10/06

(52) U.S. Cl. CPC G06Q 10/06312
USPC 705/7.22

(57) ABSTRACT

A non-transitory, computer-readable storage device comprises software that, when executed by a computer, causes the computer to track one or more well work opportunities. For example, the software may cause the computer to receive input, from a user input device, information pertaining to well work opportunity for an existing production rig, and perform an analysis of the well work opportunity based on the information to compute an incremental increase in rate of production from the production rig and a time period by which an investment will be paid back. The software may also cause the computer to compare the incremental increase in rate of production and the time period to a table that cross references incremental rates of production to time periods, assign a ranking to the well work opportunity based on the comparison, and display the ranking.

### CROSS-REFERENCE TO RELATED APPLICATIONS

This application claims priority to U.S. Provisional Application 61/579,100 titled “Well Work Opportunity System,” filed Dec. 22, 2011 and incorporated herein by reference.

### STATEMENT REGARDING FEDERALLY SPONSORED RESEARCH OR DEVELOPMENT

Not applicable.

### BACKGROUND

For many hydrocarbon producing wells, production tapers off over time. For example, in hydrocarbon producing wells that produce both gas and liquid, the well may initially produce gas with sufficient pressure and volumetric flow to lift produced liquids to the surface. However, over time, the produced gas pressure and volumetric flow rate decrease until they are no longer capable of lifting the produced liquids to the surface. Specifically, as the life of a natural gas well matures, reservoir pressures that drive gas production to the surface decline, resulting in lower production.

There are a variety of jobs, often referred to as “well work opportunities,” that can be performed on a well (e.g., hydraulic fracturing, fracture acidizing, etc.) to maintain and/or enhance production over time. For a given well, a variety of different types of jobs may available, and each type of job requires an investment. Thus, decisions must be made as to what jobs to do on a well based on the required investment and the anticipated payback from enhanced production. Further, some companies own and operate hundreds or even thousands of wells across numerous regions and countries. Carefully thought through decisions need to be made to allocate investment dollars to maximize the return on the investment.

Typically, seamless visibility to all possible opportunities across all wells is not available. Rather, individual, disparate opportunities are often evaluated, prioritized, scheduled, and tracked in an ad hoc, or semi-regional, fashion thereby precluding well-informed decisions to be made for future jobs on existing wells across a whole region. Further, historical results of previously implemented jobs are not readily available in an efficient electronic fashion, and thus, are not always taken into account when making decisions on new jobs. As a result, a new job proposed for a well may be less successful than designed if previously performed similar jobs that failed were not considered.

### BRIEF SUMMARY OF THE DISCLOSURE

Embodiments described herein include a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

In accordance with an embodiment of the invention, a software tool, executed by a computer, is provided. The software tool tracks various wells and well work opportunities (e.g., fracing, acidizing, casing repair, etc.) and their economic impact in a uniform, consistent manner. Decisions can readily be made using this tool as to the best (e.g., highest return on investment) jobs to perform on certain wells. Such decisions can take into account all wells tracked by the software and all possible well work opportunities.

One embodiment is directed to a non-transitory, computer-readable storage device comprising software that, when executed by a computer, causes the computer to perform various actions such as receive input, from a user input device, information pertaining to a well work opportunity for an existing production well. The software may also cause the computer to perform an analysis of the well work opportunity based on the information to compute an incremental increase in rate of production from the production rig and a time period by which an investment will be paid back. Further, the software may cause the computer to compare the incremental increase in rate of production and the time period in a table that cross references incremental rates of production to time periods, and assign a ranking to the well work opportunity based on the comparison. The computer may then display the ranking.

Another embodiment is directed to a non-transitory, computer-readable storage device comprising software that, when executed by a computer, causes the computer to receive as input information on a plurality of well work opportunities regarding a plurality of existing wells. Each well work opportunity may have a plurality of stages during its lifecycle. The software further causes the computer to track each of the well work opportunities through a plurality of phases. For each well work opportunity, the computer stores and displays history information, comparison information comparing a plurality of the well work opportunities, and a quantity of well work opportunities that are in each of the plurality of stages. The software may also cause the computer to display an economic ranking for each well work opportunity.

Yet another embodiment is directed to a non-transitory, computer-readable storage device comprising software that, when executed by a computer, causes the computer to receive as input information on a plurality of well work opportunities regarding a plurality of existing well work execution rigs. Each well work opportunity has a plurality of stages during its lifecycle. The software further causes the computer to determine a number of days each well work opportunity remains in a given stage and, for each stage, compute an average number of days a plurality of well work opportunities are in that particular stage and display a graph containing the computed averages.

Other embodiments are directed to a non-transitory, computer-readable storage device comprising software that, when executed by a computer, causes the computer to receive as input a user selection of a well work opportunity from among a plurality of well work opportunities. The selected well work opportunity is for an existing well. For the selected well work opportunity, the software causes the computer to retrieve from a data storage device a history of all well work opportunities previously performed on the well. The history includes, for each previously performed the well work opportunity, a date of the well work opportunity, a type of the well work opportunity and a result or status of the well work opportunity. The computer also displays the retrieved history on a display device in tabular form.

Another embodiment is directed to a non-transitory, computer-readable storage device comprising software that, when executed by a computer, causes the computer to receive as input a user filter selection of well work opportunities associated with well work execution rigs. Each well work opportunity has a plurality of stages in a lifecycle. Based on the user filter selection, the software causes the computer to select a subset of the well work opportunities and retrieve from a data storage device information of the selected well work opportunities. Based on the retrieved information, the software causes the computer to compute an average number of days the selected well work opportunities remaining in each stage and display a chart on a display device indicative of the computed averages.

### BRIEF DESCRIPTION OF THE DRAWINGS

For a detailed description of exemplary embodiments of the disclosure, reference will now be made to the accompanying drawings in which:

FIG. 1 shows a system in accordance with various embodiments;

FIG. 2 illustrates a home page of user interface of a well opportunity software application in accordance with various embodiments;

FIGS. 3A and 3B illustrates a user input interface in accordance with various embodiments;

FIG. 4 illustrates an economic ranking matrix in accordance with various embodiments;

FIG. 5 illustrates a user interface showing results of an economic model applied to a given well work opportunity for a well in accordance with various embodiments;

FIG. 6 shows an example of task manager user interface in accordance with various embodiments;

FIG. 7 illustrates a report selection user interface in accordance with various embodiments;

FIG. 8 illustrates a report in accordance with various embodiments;

FIG. 9 illustrates another report in accordance with various embodiments;

FIG. 10 illustrates a method in accordance with various embodiments;

FIG. 11 shows yet another method in accordance with various embodiments;

FIG. 12 illustrates a user interface by which a user can input handover dates; and

FIGS. 13A and 13B show examples of user interfaces by which batch editing can be performed.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection can be through a direct connection, or through an indirect connection via other devices, components, and connections.

In accordance with various embodiments of the invention, a system is provided that permits well work opportunities to be entered, tracked, and analyzed throughout their life cycles. As used herein, a “well work opportunity” or “opportunity” refers to an idea or job for modifying an existing well to enhance production from the well. Opportunities are preferably selected and implemented in a cost effective manner given the investment the opportunity may require and the anticipated increase in production. The term well work idea is synonymous with well work opportunity. A large variety of types of well work opportunities exist such as fracing operations, acidizing, artificial lift, casing repair, etc. Different opportunities for a well may require different investments, and the pay out from performing a given opportunity on an existing well may vary from opportunity to opportunity. Further, certain well work opportunities on certain wells may result in a higher return on investment (ROI) than the same or different opportunities being performed on different wells in the same region or in different regions altogether. The embodiments described herein relate to a system that permits efficient tracking and analyzing of numerous possible well work opportunities on multiple wells in various regions so that a cost effective decision can be made to select the best well work opportunities to implement.

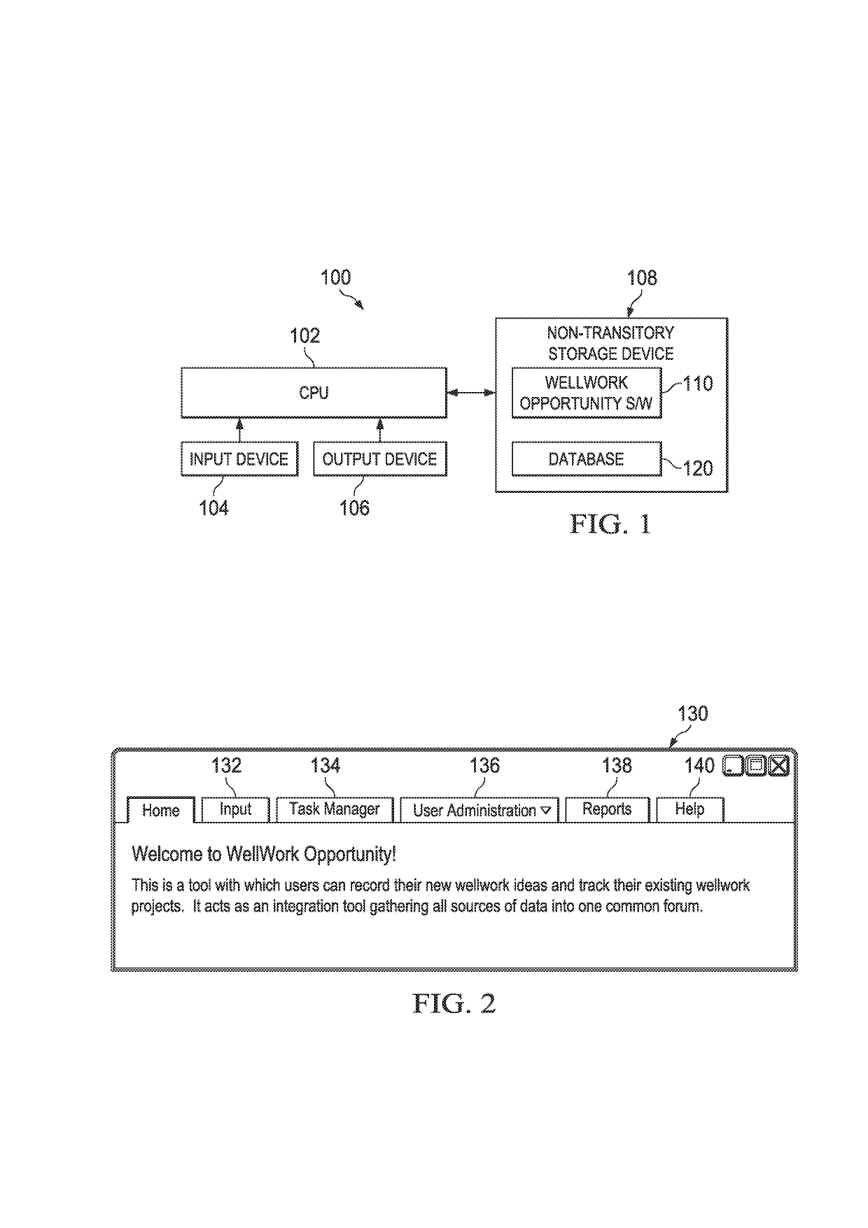

FIG. 1 illustrates a system 100 in accordance with various embodiments. System 100 comprises a central processing unit 102 coupled to an input device 104, an output device 106, and a non-transitory storage device 108. The input device 104 may include any one or more of a keyboard, a keypad, a mouse, a trackball, or other suitable type of input device by which a user can interact with the system 100. The output device 106 may include a display. The non-transitory storage device 108 may include volatile or non-volatile storage devices such as random access memory (RAM), a hard disk drive, Flash storage, etc. The non-transitory storage device 108 may include a single storage device or multiple storage devices as desired.

The non-transitory storage device 108 includes well work opportunity software 110 and a database 120. The well work opportunity software 110 comprises code that is executable by the CPU 102 and, when executed by the CPU, performs some or all of the functionality described herein. Any reference herein to the software 110 performing a certain function means that the software, when executed by the CPU, performs the stated function. The database 120 contains all well work opportunities previously entered, and information about each opportunity such as its history, economic analysis, priority, etc.

FIGS. 2-3B, 6, and 7 provide user interfaces shown on output device 106 as a user interacts with the well work opportunity software 110. FIG. 2 shows a home screen 130 of the well work opportunity software 110. The home screen 130 includes multiple user-selectable tabs 132-140. Tab 132 is an Input tab in which a user is able to input, as described below, a new well work opportunity for storage in the database and tracking by the software 110. Tab 134 is a task manager tab in which, as described below, a user can filter, sort and view various well work opportunities on various wells. Tab 136 is a user administration tab in which permits users to be registered with the system. Tab 138 is a reports tab in which a user can select and run various reports as described below. Tab 140 is a help tab in which a user can receive help on the use of the well work opportunity software 110.

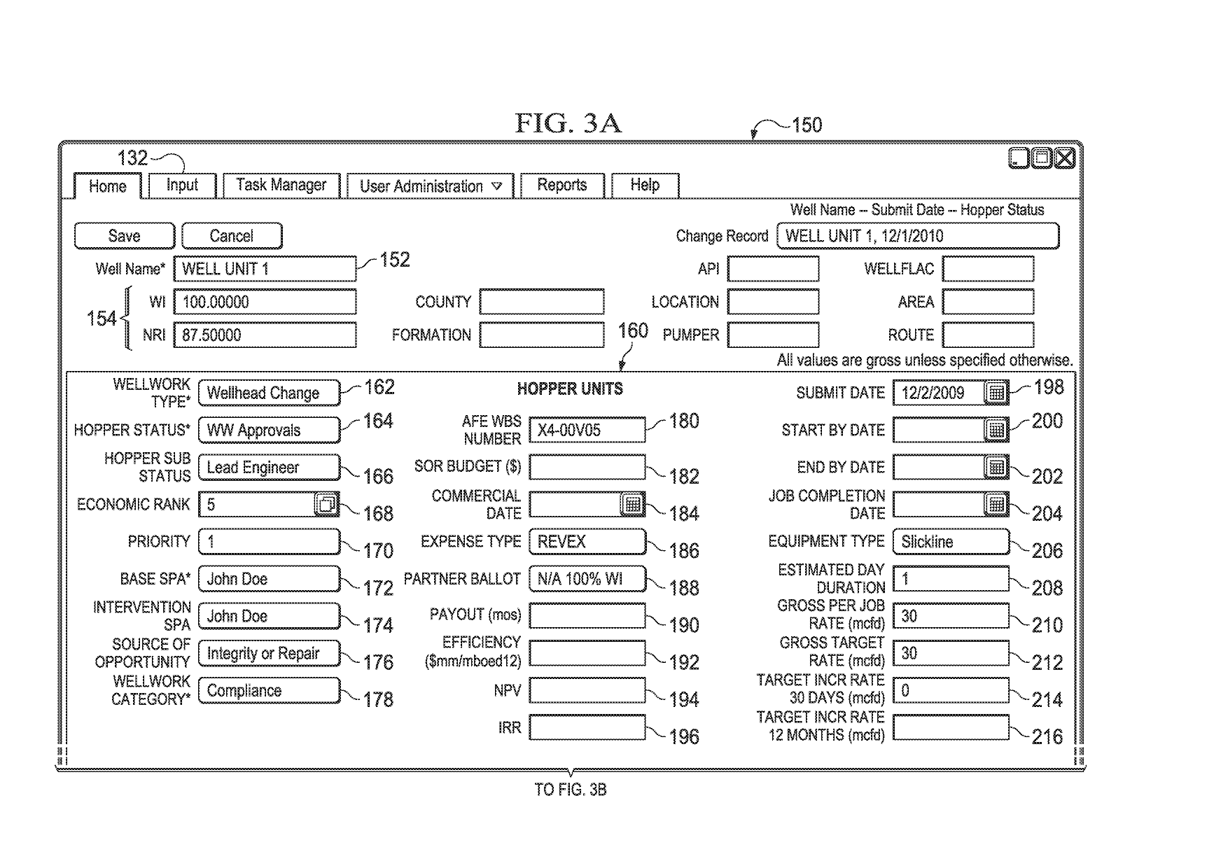

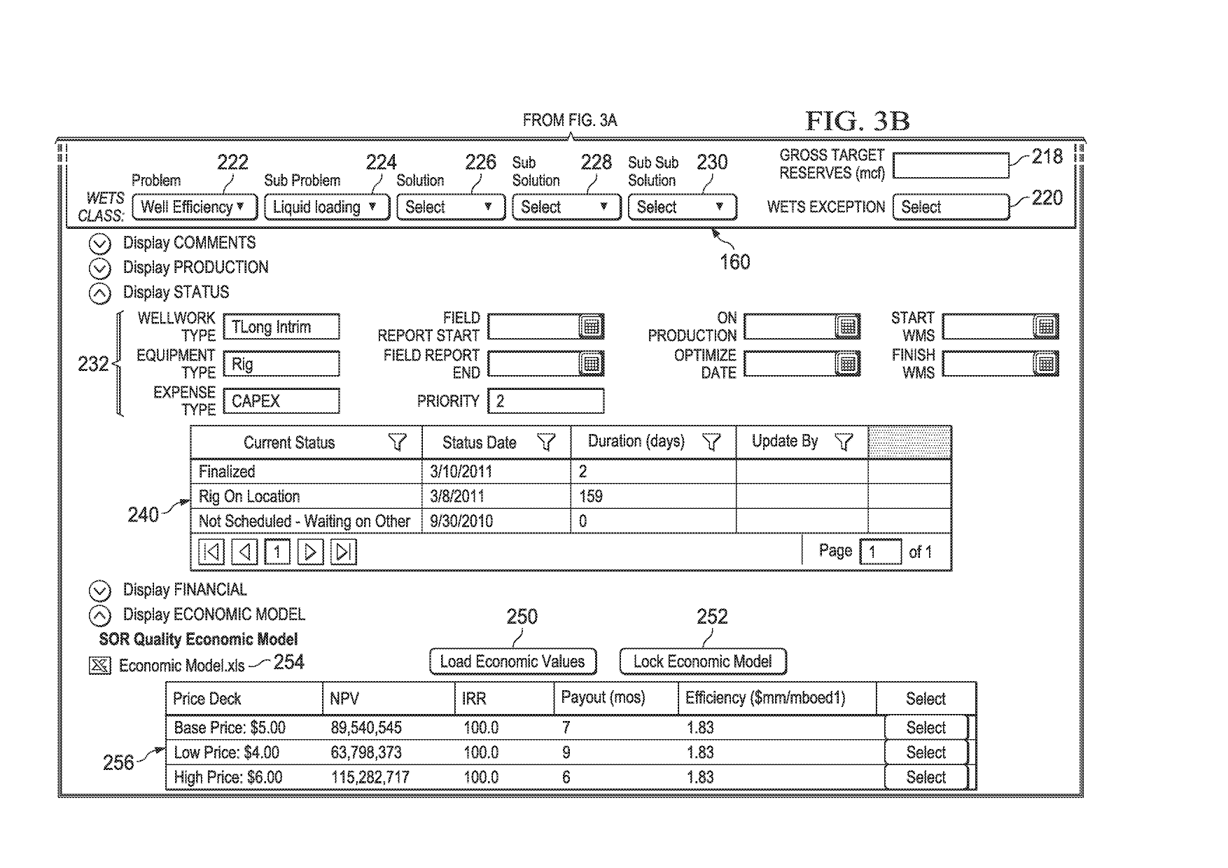

FIGS. 3A-3B illustrate an example of the user interface 150 implemented by the input tab 132 by which a user may input a new well work opportunity into database 120. FIG. 3B is a continuation of the user interface of FIG. 3A. The user interface 150 includes various input fields and drop down menus. For example, at 152, the user may input a well name. Reference numeral 154 includes various input fields which specify information about, for example, the location of the well. Some or all of the information comprising 154 uniquely identifies the well for which the well work opportunity is being entered. For example, the county in which the well is located can be specified as well as the formation, and specific coordinates of the well site.

The user interface 150 for the input tab also includes a Hopper Inputs section 160 in which various pieces of information are input and/or presented to the user. Some of the fields are input fields into which for user enters values directly or selects from a drop-down menu or other mode of input. Other fields are exclusively output fields and are populated from the database 120 once the well is identified in the fields of 154. The various information items in the Hopper Inputs section 160 includes items 162-220:
Wellwork Type (162)—a drop-down menu that provides multiple choices of various types of work that can be performed on a well. Examples include wellhead change, fracing, etc.
Hopper Status (164)—a drop-down menu that allows the user to specify the status of the well work opportunity. Examples include well work idea, well work approvals, and well work scheduled.
Hopper sub-status (166)—a drop-down menu that allows the user to specify sub-status information. Examples include BM PE evaluation, subsurface engineering input, and BM team lead.
Economic rank (168)—presents the result ranking of an economic analysis (described below). In some embodiments, the economic rank is in a range of 2 to 5 with 2 being the highest economic ranking and 5 being the lowest economic ranking.
Priority (170)—a drop-down menu that allows the user to specify a priority level for the well-work opportunity. In some embodiments, a priority level of 1 is the highest level. The system will suggest an initial prioritization based on economic rank but the user can manually alter as urgency warrants.
Base Single Point of Administration (SPA) (172)—a drop-down menu in which a particular person's name can be selected to be the Base SPA. The Base SPA is a person who is responsible for the well work opportunity and may be the person that initiated the well work opportunity in software 110.
Intervention SPA (174)—a drop-down menu in which a particular person's name can be selected to be the Intervention SPA. The Intervention SPA is a person who completes tasks required by the Wells Organization such as cost estimates and workover procedures and logistics with vendors.
Source of Opportunity (176)—a drop-down menu that provides choices as to nature of the original idea of the particular well work opportunity. Examples include integrity or repair, production losses, and well review.
Well Work Category (178)—a drop-down menu that provides choices as to a category for the well-work opportunity. Examples, include compliance (i.e., whether the opportunity is ensure the well is compliance with a local or federal regulation), rate/reserve protect (fix something that has broken or return production to previous levels), and surveillance/diagnostics.
AFE WBS Number (180)—a field containing the accounting code usually (e.g., a SAP number).
SOR Budget (182)—a field which contains the cost for the job.
Commercial date (184)—a field containing the date on which the AFE number was sent.
Expense Type (186)—a field which describes which budget funds should be used. For example REVEX, CAPEX or IM (Integrity Management).
Partner Ballot (188)—a field which specifies whether approval will need to be obtained by working interest owners (e.g. N/A, 100% WI, Partners Approved or Non-consent).
Payout (190)—a field that specifies how long (e.g., in months) it will take for the investment in the well work opportunity to pay for itself, for example, from the resulting uplift in production resulting from the opportunity.
Efficiency (192)—a field which provides a metric showing the value of the well work opportunity (e.g., in millions of dollars divided by a 12 month incremental production).
Net Present Value (NPV) (194)—a field that specifies the net present value of the well work opportunity based on the economic model.
Internal Rate of Return (IRR) (196)—a field that specifies the net present value of the well work opportunity based on the economic model.
Submit Date (198)—specifies when the well work opportunity was entered into the database 120.
Start By Date (200)—indicates the date by which the well work opportunity is actually begin.
End By Date (202)—indicates the date by which the well work opportunity should be completed.
Job Completion Date (204)—indicates when the job identified by the well work opportunity actually completed.
Equipment Type (206)—a drop-down menu by which the user can specify which equipment will be needed for the well work opportunity.
Estimated Day Duration (208)—a field in which the user can enter the number of days estimated for the job identified by the well work opportunity to require.
Gross Pre-Job Rate (210)—a field in which the user can enter the production rate from the well before the job identified by the well work opportunity is performed.
Gross Target Rate (212)—a field in which the user can enter the anticipated production rate from the well after the job identified by the well work opportunity is performed.
Target Incremental Rate 30 Days (214)—a field the software 110 automatically populates with the difference between the values in the Gross Pre-Job Rate and Gross Target Rate fields. The Target Incremental Rate 30 Days is the anticipated “uplift” in production rate on a monthly basis from the well after performing the job identified by the well work opportunity. Not all jobs result in a positive uplift. For example, a job that is purely compliance related may not result in any increase in production.
Target Incremental Rate 12 Months (216)—Similar to Target Incremental Rate 30 Days but normalized to a yearly basis.
Gross Target Reserves (218)—a field that indicates the gross target reserves in the field for which the well is located.
Well Evaluation and Tracking System (WETS) Exception (220)—a field that indicates if a job should not be in WETS for reasons such as Plug & Abandon, SWD Well or Temporary Abandon.
WETS Class fields 222-230 include drop-down menus to input a problem 222, a sub-problem 224, a solution 226, a sub-solution 228, and sub-sub-solution 230 used to enable effective cross-reference of job types in a separate well work post-appraisal system.
Fields comprising section 232 include various input fields in which the user can input information about the problem or root cause and then the solution per categories suggested in WETS.
Status box 240 provides status information about important comments for the well that have no other place such as a regulatory requirement or seasonal restrictions

Referring to FIG. 3B, data can be input about the well work opportunity into an economic model by selecting button 250, which in some embodiments, causes a spreadsheet (e.g., spreadsheet 254) to open. The spreadsheet encodes any desired economic model, and provides cells into which a user is prompted to enter certain data about the well work opportunity. The user may enter such information into the economic model encoded by the spreadsheet as incremental uplift, operation site, and operating expenses.

Button 252 can be selected to lock the economic model so no further changes can be made to it. Locking the economic model may be desirable to ensure that the evaluation and cost estimation of the well work opportunity is based on a known economic model that can be easily verified. Locking the model to prevent any further changes provides a data integrity chain by which it is assured which economic model drove the evaluation of the well work opportunity.

Table 256 provides various possible scenarios for the well work opportunity based on the price of the oil or gas being produced. For each scenario, the NPV, IRR, payout, and efficiency are computed based on the economic model.

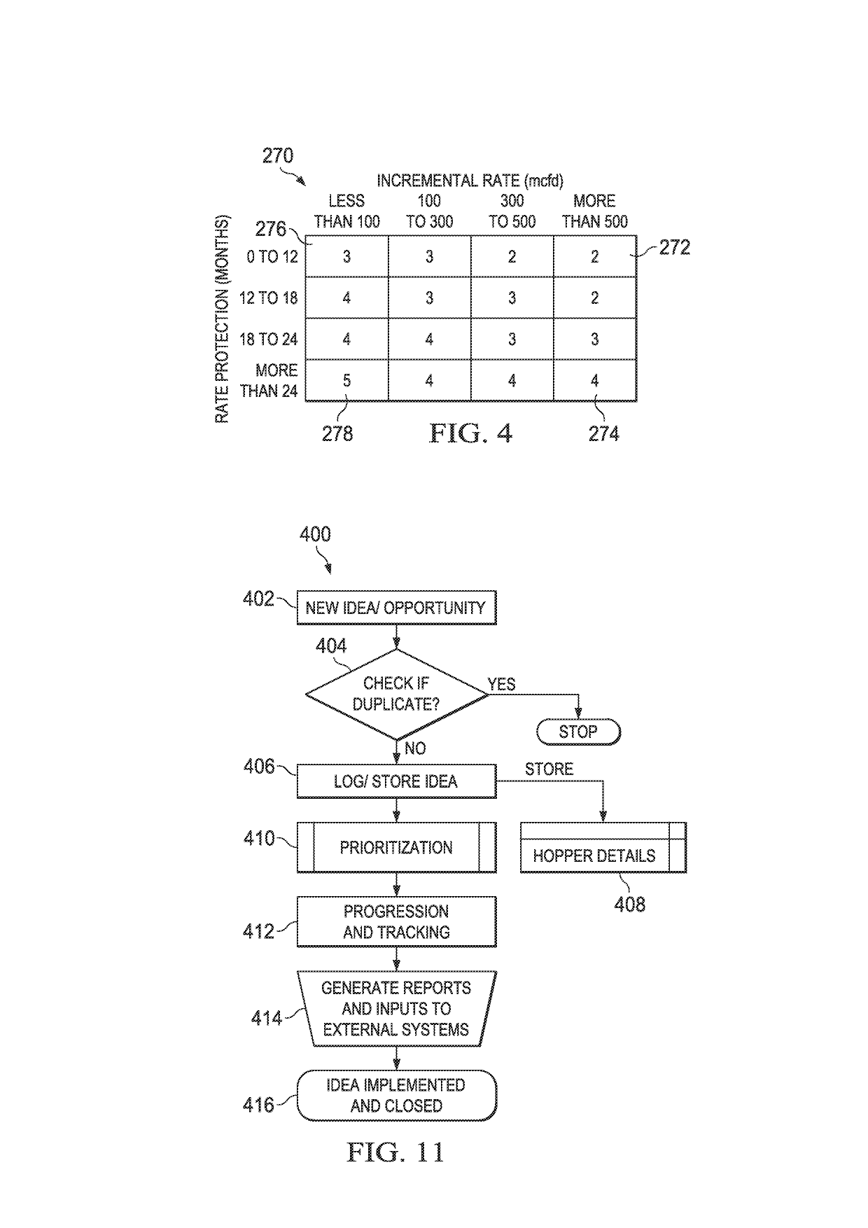

FIG. 4 shows an example of economic ranking matrix 270 that is used to economically rank a well work opportunity based on its economic model. The economic illustrative ranking matrix 270 of FIG. 4 comprises 16 cells arranged as 4×4 matrix. The rows specify various ranges of rate protection which refers to the expected time period by which the investment in the job defined by the well work opportunity will be paid back. In the example of FIG. 4, the various rate protection ranges include 0 to 12 months, 12 to 18 months, 18 to 24 months, and more than 24 months. Different ranges can be implemented as well as a different number of ranges. The columns show various ranges of incremental rate which refers to the anticipated uplift or increase in production resulting from the job defined by the well work opportunity. The units may be in millions of cubic feet per day (mcfd), and the ranges in the example of FIG. 4 include less than 100 mcfd, 100 to 300 mcfd, 300 to 500 mcfd, and more than 500 mcfd.

The integers in each cell of the economic ranking matrix 270 represent economic rankings. The numbers are in the range of 2 to 5 with 2 being the highest economic ranking and 5 being the lowest economic ranking as noted previously. In general, the sooner the payback occurs (i.e., short time for the rate protection) and the higher is the incremental production rate, the higher is the economic ranking (lower ranking integer).

For example, the far right upper corner of the matrix (272) has a very high economic ranking of 2 because that cell corresponds to the shortest rate protection of 0 to 12 months and has the highest incremental rate of more than 500 mcfd. The lower right hand cell 274 also corresponds to the highest incremental rate (more than 500 mcfd) but also has the longest rate protection of more than 24 months. Thus, that cell's economic ranking (4) is lower than for cell 272. Cell 276 is in the upper left hand corner of the matrix and thus corresponds to short rate protection of 0 to 12 months but has the lowest incremental rate of less than 100 mcfd. Thus, its economic ranking (3) is also lower than for cell 272. The lower left hand corner 278 corresponds to both the highest rate protection of more than 24 months and the lowest incremental rate of less than 100 mcfd and thus its economic ranking (5) is the lowest of any cell in the table. The economic rankings populated into the economic ranking matrix 270 can be any suitable set of rankings. FIG. 4 is one example.

FIG. 3A included priority field 170 as noted above. The priority field allows a user to enter a priority, and decisions can be made by, for example, management as to which well opportunities to pursue based on the priority levels. By including both economic rankings and a priority levels, a user is able, for example, to prioritize a well as high despite its economic ranking being relatively low. The user may consider factors other than the economics when assigning a priority level. An example of a factor that might drive a well work opportunity to a high priority level is a safety concern.

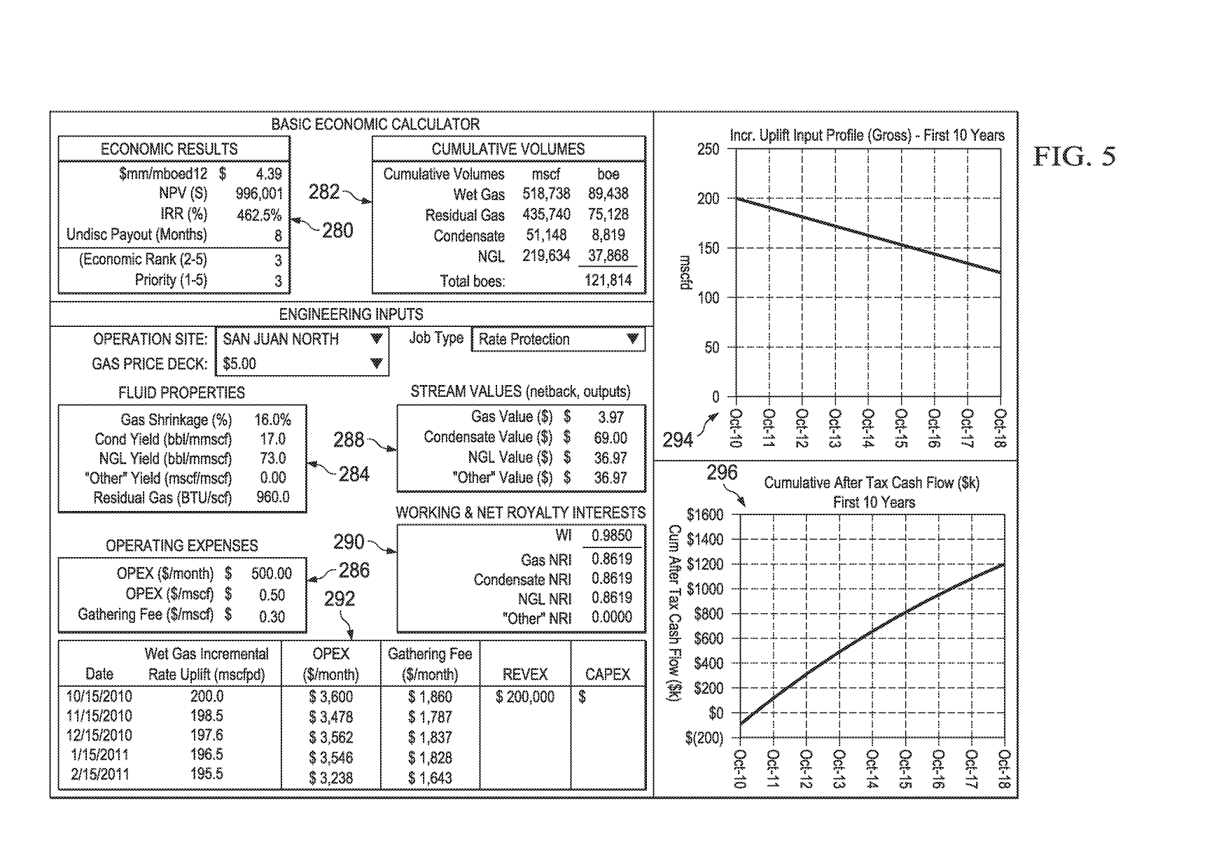

FIG. 5 shows various results of the economic model. For example, table 280 provides NPV and IRR values computed by the economic model. Also shown is the economic ranking determined for the well work opportunity. The economic ranking results from the software 110 cross referencing the incremental (from field 214 or 216 in FIG. 3A) with the rate protection (payback time period) computed by the economic model and also shown in field 190 in FIG. 3A. Cross referencing these two values in the economic ranking matrix 270 results in an integer economic ranking as described above.

Table 282 in FIG. 5 provides information on cumulative volumes of wet gas, residual gas, condensate, and Natural Gas Liquids (NGL). Various engineering data are also shown. Fluid properties are shown at 284, and operating expenses at 286. Further, stream values and working and net royalty interest data is shown at 288 and 290, respectively. Uplift data is shown at 292. Graph 294 plots the incremental uplift as a function of time, and graph 296 plots the cumulative after tax cash flow as a function of time.

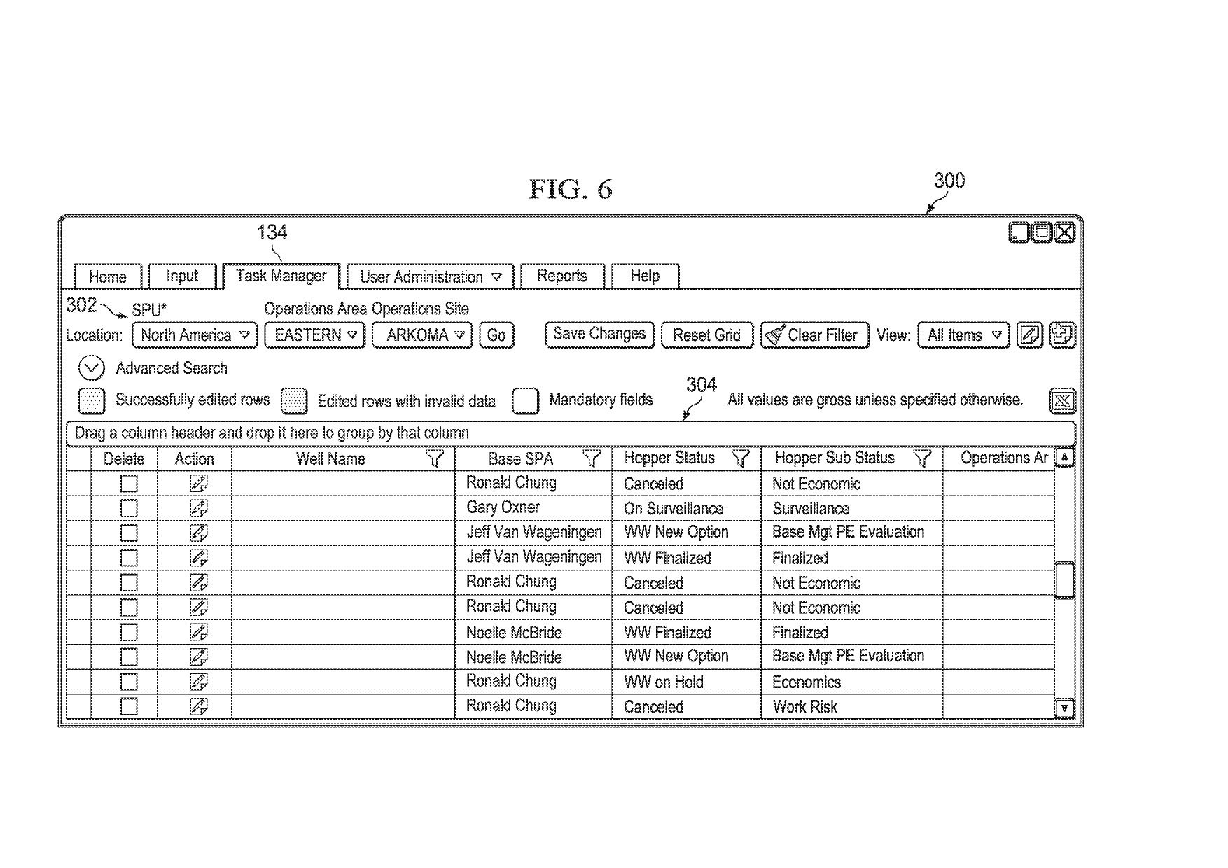

FIG. 6 shows an example user interface 300 for the task manager tab. The task manager user interface 300 permits a user to view a list of wells and various items of information about each such well. A set of filters 302 is provided by which the user can narrow down the list of wells to be viewed. The filters may permit filtering, for example, based on location. Table 304 includes the wells viewable by the user. Which fields of information are displayed can be configurable and the set of wells can be sorted by selecting (e.g., clicking on), the desired column on which to base the sort. For example, the wells can be sorted based on well name (alphabetical order). A user can select a given well (single or double click) and the software 110 then transitions to the input tab 132 in which information about the selected well is displayed as described above.

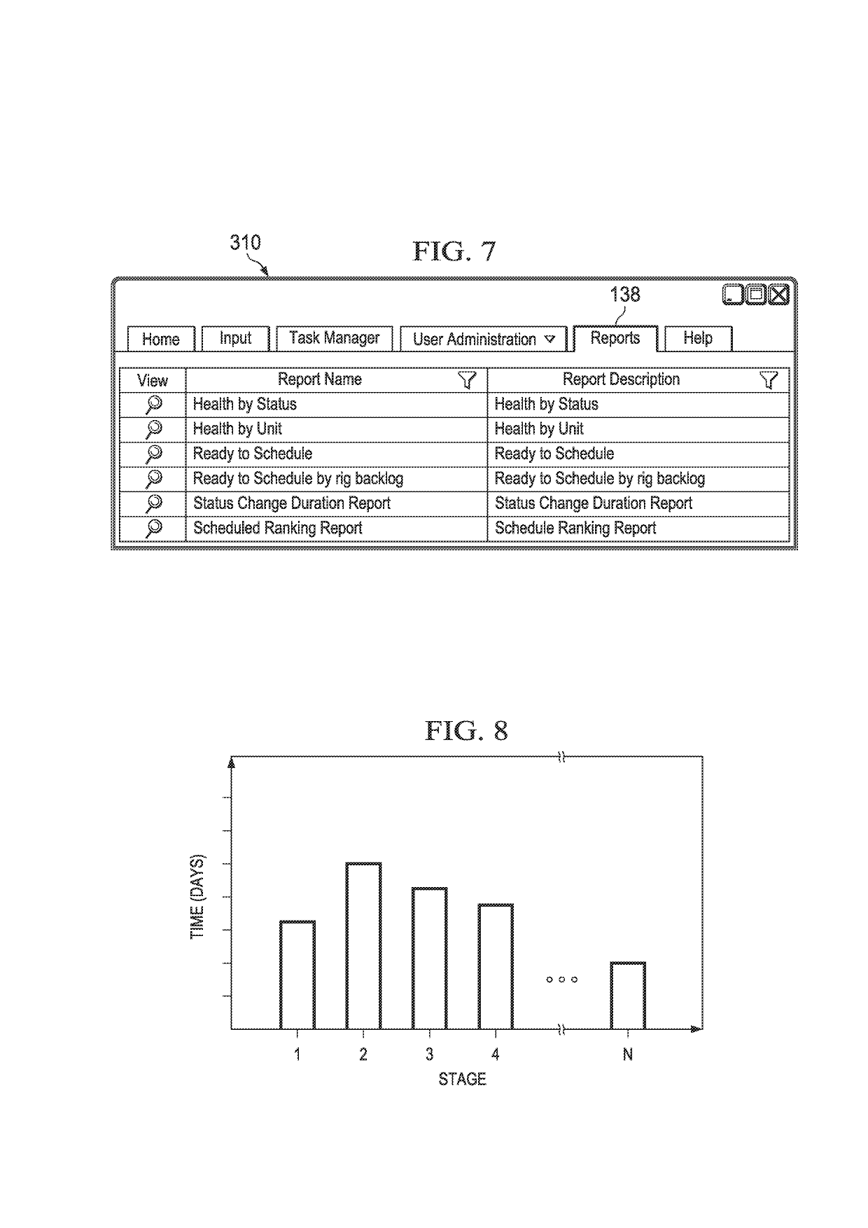

FIG. 7 shows an example user interface 310 for the reports tab 138. A list of user-selectable reports is shown. The user can choose any of the reports to be run. The Health by Status report shows numbers of jobs in various categories or stages in the process. The Health by Unit report shows how many jobs are in a stage and if more jobs are needed to be added. The Ready to Schedule report shows jobs ready to be scheduled on rig lines. The Ready to Schedule by Rig Backlog report shows how many days of work the rigs have lined up and can help determine if a change in the number of rigs is needed. The Status Change Duration Report shows how long jobs remain in a stage of the process. The Scheduled Ranking Report shows priority and economic ranking.

Different or additional report can be offer to the user as well. For example, a Date Tracking report can be run by the software 110 to indicate low long a particular well work opportunity remains in each of its various stages. Alternatively or additionally, this report can compute and provide such stage time period information across multiple well work opportunities (e.g., the time periods in each stage of multiple opportunities can be averaged together). The results can be presented in any suitable format such as a bar chart.

FIG. 8 shows an example of bar chart in which each of n stages (designated as 1 to n) are shown along the x axis and the height of each bar for each stage corresponds to the time, or average time, in that particular stage. In some examples, the various stages of a well work opportunity include:

(1) New Opportunity—under initial evaluation

(2) SOR Package in Progress—being prepared for management review

(3) Intervention Package in Progress—procedures being prepared by engineers

(4) Approvals—waiting on approvals of lead engineer, management, etc.

(5) Ready to Schedule—waiting on scheduling, facilities, construction, etc.

(6) Scheduled—scheduled and waiting on workover rig, scheduled for rigless work, waiting on wireline unit, etc.

(7) In Progress—job being performed on rig at location

(8) Back on Production—job completed, well is being optimized

(9) Finalized—job completed, well optimized

(10) On Surveillance—surveillance underway

(11) On Hold—waiting on economics to change, stalled by high pressure, stalled by weather, stalled by high rate, stalled by land owner issues, etc.

(12) Cancelled—well work opportunity cancelled.

Another report that the software 110 can run is a Well History report. This report retrieves the well work opportunity history of a given well (i.e., the jobs that have actually been performed on the well), their dates of completion, and a status result of each such job. The status result may include financial value attributed to that opportunity.

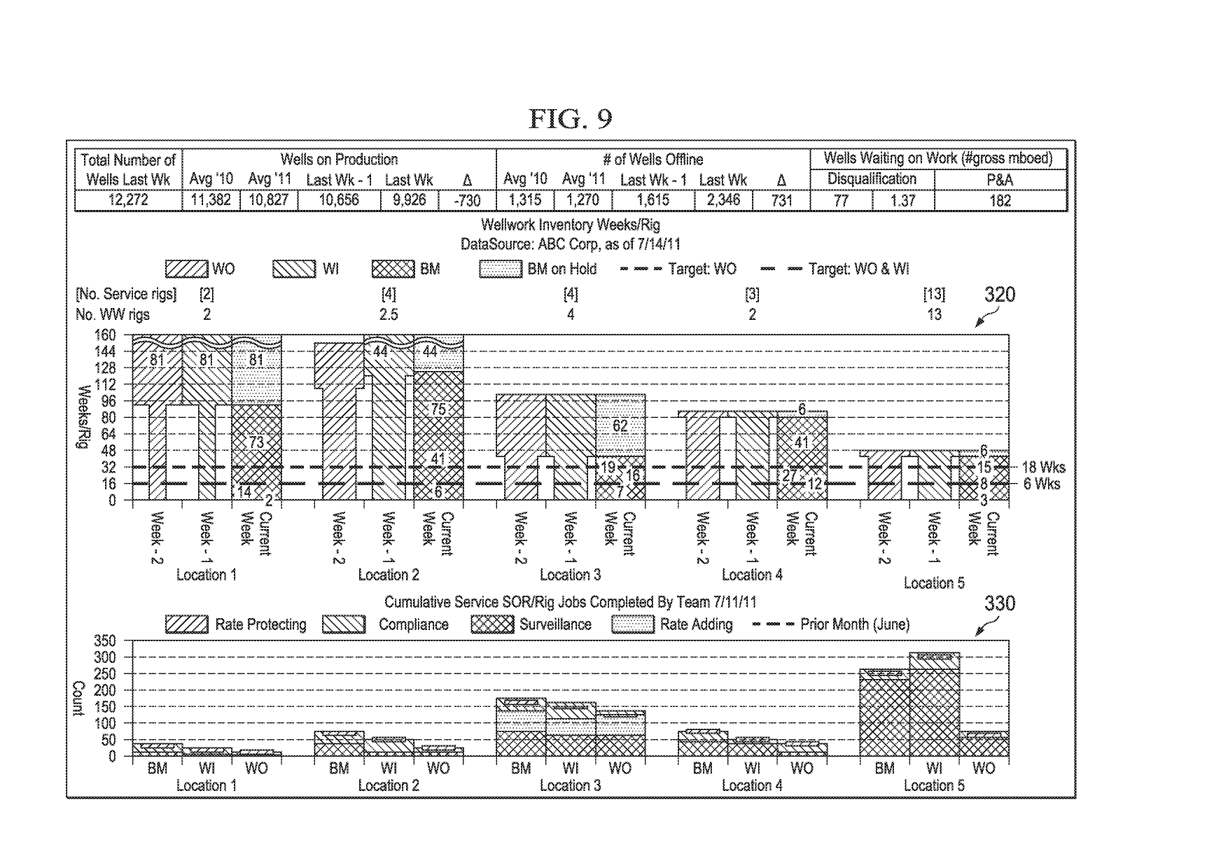

Yet another report that the software can run is a Job Analysis report. An example Job Analysis report is shown in FIG. 9. This report shows at 320, for each of multiple locations/regions, a three inventory history of the well work opportunities for that location or region. For each week, the number of well work opportunities in the various stages are depicted in, for example, stacked bar form. At 330, the report shows, for the various locations, changes in the well category from week to week.

A person may be responsible for each stage of a well work opportunity. The person responsible for a given stage may be different than the person responsible for another stage. A different person may be responsible for each stage. In some embodiments, once a given stage is completed and the status of that stage is updated accordingly (e.g., on the “view” screen under “status”), the Wellwork Opportunity Software 110 automatically generates and sends a message (e.g., an email, a text message, etc.) to the person responsible for the next stage. The message informs the recipient that performance of his or her stage now can begin. Each such recipient's name is input into the system and associated with the corresponding job stage or sub-stage.

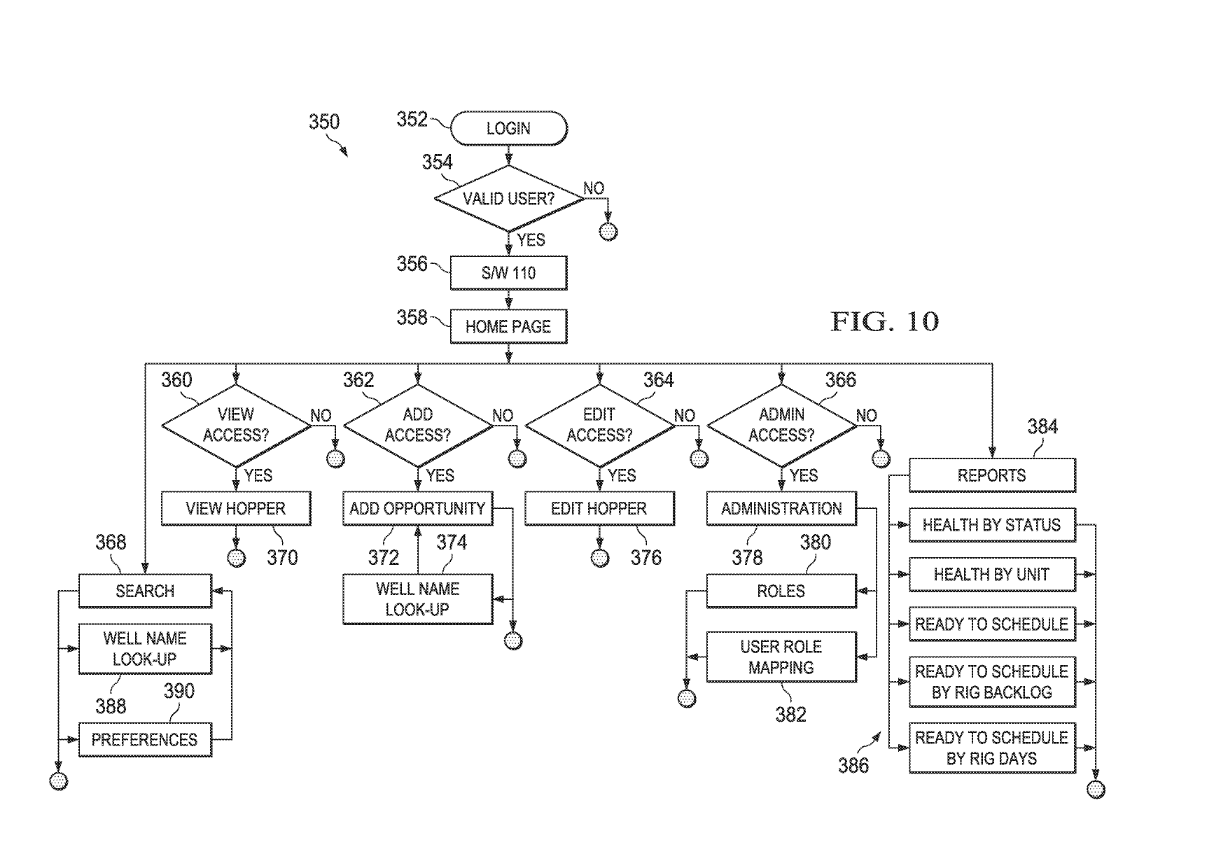

FIG. 10 illustrates a method that may be performed by software 110 in accordance with various embodiments. The actions depicted may be performed in the order shown or in a different order as desired.

At 352, a user logs in to a system on which the software 110 runs. The user may be required to enter a valid password or other suitable type of user authenticatable credential (e.g., fingerprint scan). If the user is successfully authenticated at 354, the well work opportunity software 110 executes for the user and the home page 130 (FIG. 2) is presented to the user. The home page, and the software generally, provides the user with a variety of choices. For example, the user can view a well work opportunity (360), add a well work opportunity (362), edit an existing well work opportunity (364), perform an administrative access (366) or perform a search 368. If the user decides to view an opportunity (360), then the software transitions to the view hopper (input tab) at 370. If the user decides to add a well work opportunity (362), then the user may look up (374) a well from the database 120 for which to add an opportunity (372). If the user decides to perform an administrative access (366), then various functions such as defining certain roles (380) can be performed as well as mapping users to the various roles (382). If the user opts to run a report then any of the reports at 386 can be performed as well as any other report described above or later created. If the user performs a search (368), then the user can look up a desired well and set preferences (e.g., regions, engineer name, job type, well type, etc.) 390.

FIG. 11 shows another method 400 related to the lifecycle of a well work opportunity. This method is performed using the well work opportunity software 110 and computer described above. At 402, the method includes inputting a new well work opportunity into the database 120 using the input tab 132 as described above. At 404, the software 110 determines if the newly crated well work opportunity is a duplicate of an opportunity already in the database for the given well. If it is a duplicate, the method stops and the new well work opportunity may be rejected.

At 406, the new opportunity is stored in the database 120 for which various details such as those described above regarding FIGS. 3A and 3B and the economic model are stored as well. At 410, the user is able to set a priority level for the well work opportunity.

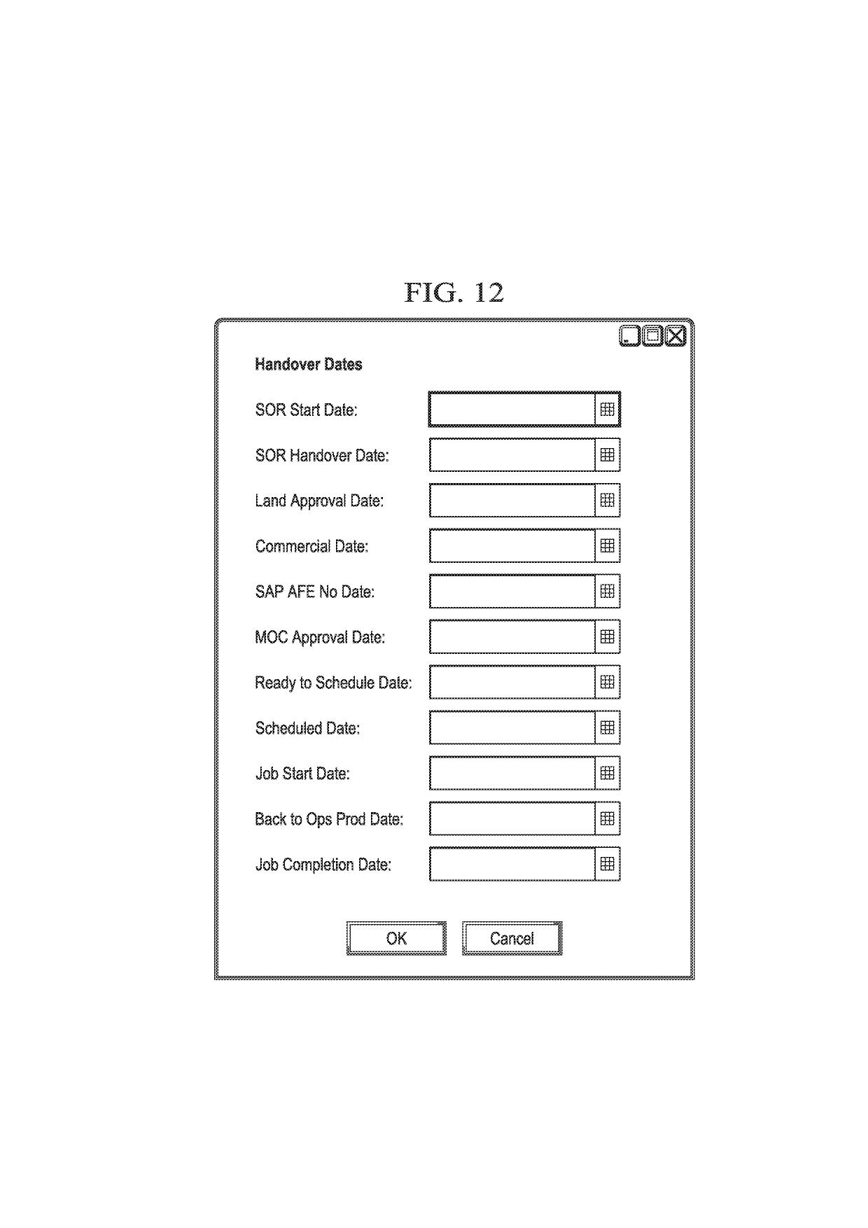

At 412, the software 110 is able to provide progression and tracking information as described herein. At any point in which a well work life cycle milestone is passed as determined by the user's Hopper Status 164 and Hopper sub-status 166 drop-down menu selections (FIG. 3A), the software 110 prompts the user to input the required handover dates with the user interface in FIG. 12. The software 110 will default the user interface FIG. 12 handover date values where applicable according to the progression of the life cycle per the Hopper Status 164 and Hopper sub-status 166 drop-down menu selections (FIG. 3A). Tracking handover dates permits users (e.g., management) to knowing which functional organization has current responsibility over a given opportunity. Knowing which organization is struggling the most as determined by high numbers of jobs sitting in their possession for long periods provides clarity in deciding where to put new company resources and where to focus new efforts to assist in efficiency goals.

At 414, the user may run various of the reports described previously. Eventually, the well work opportunity runs its course (e.g., may be performed on the well itself) and the opportunity is closed (416).

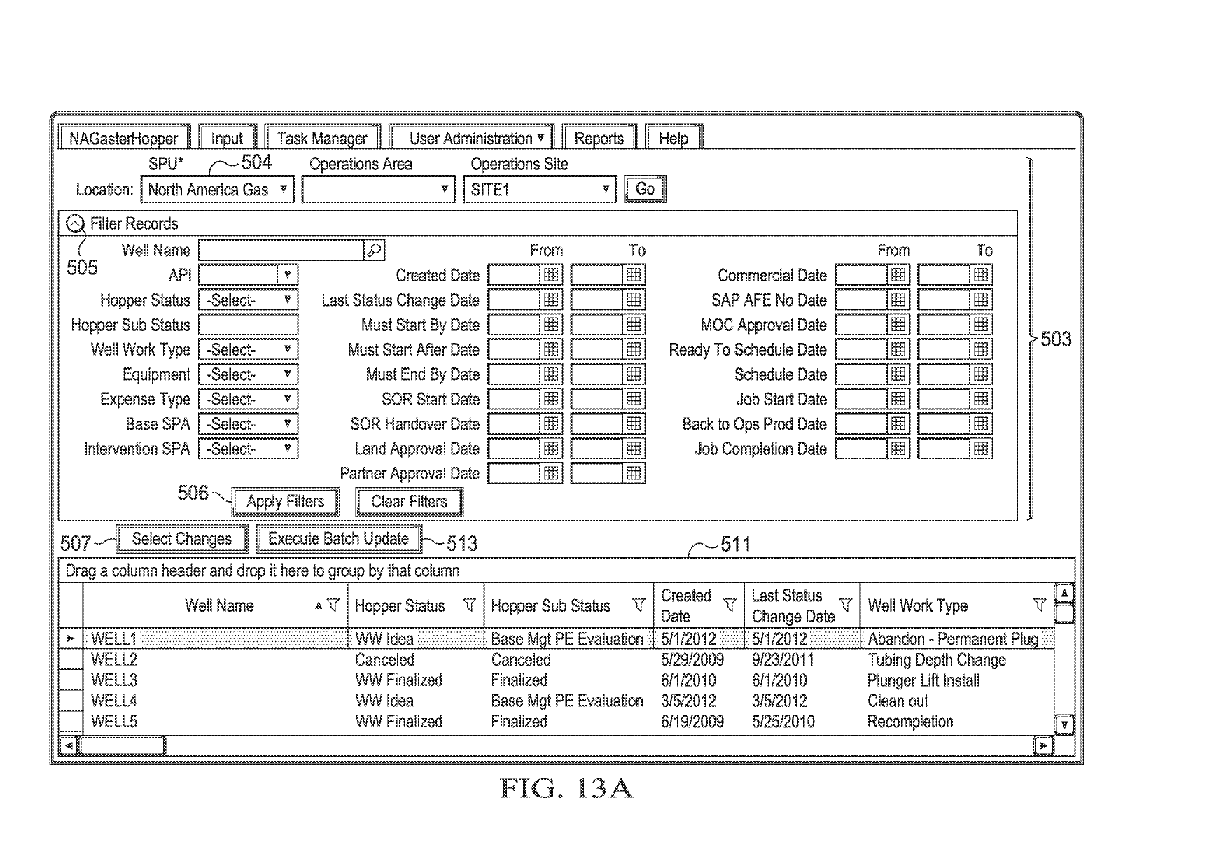

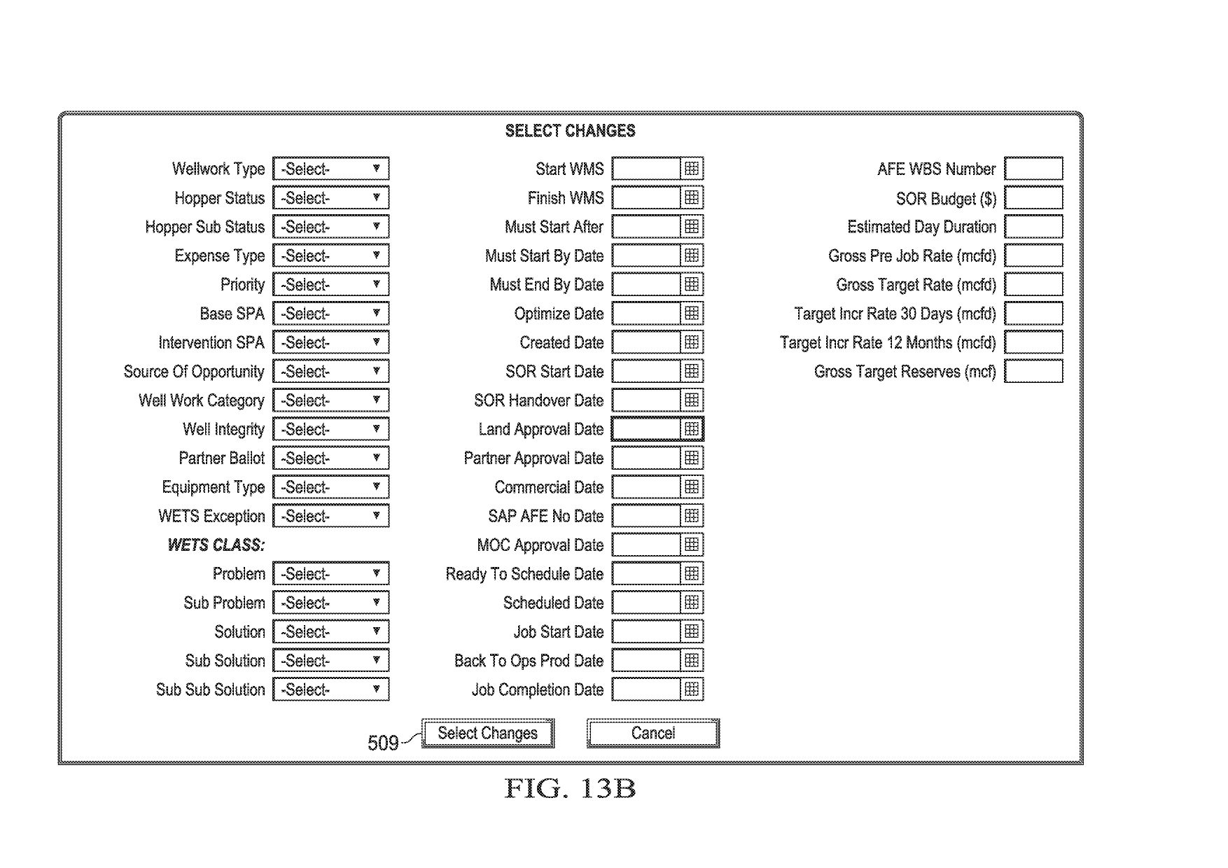

FIGS. 13A and 13B show examples of user interfaces by which batch editing can be performed on multiple well work opportunities, thereby avoiding the hassle of editing each such opportunity on an individual basis. Through the User Administration tab 136 (FIG. 2), batch editing can be selected from a drop-down menu. The batch editing user interface of FIG. 12 permits a user to filter the records to a desired record set via selection choices 504 and filtering options 505. Button 506 applies the selected filtering options 505. A “clear filters” button is also provided to clear all selection of any filtering options.

Button 507 is selected by the user to make various changes to the group of multiple filtered records (i.e., well work opportunities). The particular set of changes offered to the user can be varied from embodiment to embodiment and FIG. 13B provides one such set of options. Base SPA 172, WI SPA 174, Hopper Status 164, and Hopper Sub Status 166 are examples of changes that could be made to whole sets of data. By way of example, there may be a new engineer and all active records from existing SPA need to be changed to the new engineer, so a change is made to the Base SPA or WI SPA in this case. In another example, all jobs that have a certain status that meet certain filter criteria could all be changed to a new status and substatus with the batch editor.

Button 509 can be selected to finalize the user's selections and close the select changes user interface of FIG. 13B thereby reverting back to the user interface of FIG. 13A. At 511, the filtered records and changes can be manually verified by the user as valid, and the user then may select the execute batch update button 513 to actually implement the batch edits to the filtered records at one time.

The above discussion is meant to be illustrative of the principles and various possible embodiments. Numerous variations and modifications will become apparent to those skilled in the art once the above disclosure is fully appreciated. It is intended that the following claims be interpreted to embrace all such variations and modifications.

What is claimed is:

1. A non-transitory, computer-readable storage device comprising software that, when executed by a computer, causes the computer to:
receive input, from a user input device, information pertaining to a well work opportunity for an existing production rig;
perform an analysis of said well work opportunity based on said information to compute an incremental increase in rate of production from said production rig and a time period by which an investment will be paid back;
compare said incremental increase in rate of production and said time period to a table that cross references incremental rates of production to rate protection time periods;
assign a ranking to said well work opportunity based on said comparison; and
display said ranking.

2. The non-transitory, computer-readable storage device of claim 1 wherein the software causes the computer to receive input from a user for a priority level for the well work opportunity.

3. The non-transitory, computer-readable storage device of claim 1 wherein each well work opportunity includes multiple stages and wherein the software causes the computer to display how long a particular well work opportunity remains in each stage.

4. The non-transitory, computer-readable storage device of claim 1 wherein said well work opportunity includes multiple stages and wherein the software causes the computer to display an average time period of how long multiple well work opportunities remain in each stage.

5. The non-transitory, computer-readable storage device of claim 4 wherein the software further causes the computer to permit a user to specify a handover date associated with each stage.

6. The non-transitory, computer-readable storage device of claim 1 wherein said well work opportunity includes multiple stages, and wherein upon a given stage being completed, the software causes the computer to generate and send an alert to a person who is responsible for a subsequent stage.

7. The non-transitory, computer-readable storage device of claim 1 wherein the software causes the computer to receive input from a user to lock an economic model for the well work opportunity thereby preventing the economic model from being further edited.

8. The non-transitory, computer-readable storage device of claim 1 wherein the software causes the computer to perform the comparison by accessing an economic ranking matrix that includes economic rankings for each pair of incremental rate and rate protection time period.

9. A non-transitory, computer-readable storage device comprising software that, when executed by a computer, causes the computer to:
receive as input information on a plurality of well work opportunities regarding a plurality of existing production rigs, each well work opportunity having a plurality of stages during its lifecycle;
track each of said well work opportunities through a plurality of stages and for said well work opportunities store and display history information of each well work opportunity, comparison information comparing a plurality of said well work opportunities, and a quantity of well work opportunities that are in each of the plurality of stages; and
compute and display an economic ranking for each well work opportunity.

10. The non-transitory, computer-readable storage device of claim 9 wherein the software causes the computer to receive input from a user for a priority level for each well work opportunity.

11. The non-transitory, computer-readable storage device of claim 9 wherein each well work opportunity includes multiple stages and wherein the software causes the computer to display an average time period of how long multiple well work opportunities remain in each stage.

12. The non-transitory, computer-readable storage device of claim 9 wherein each well work opportunity includes multiple stages, and wherein upon a given stage being completed, the software causes the computer to generate and send an alert to a person who is responsible for a subsequent stage.

13. The non-transitory, computer-readable storage device of claim 9 wherein the software causes the computer to receive input from a user to lock an economic model for a given well work opportunity thereby preventing the economic model for that well work opportunity from being further edited.

14. The non-transitory, computer-readable storage device of claim 9 wherein the software causes the computer to perform the comparison by accessing an economic ranking matrix that includes economic rankings for each pair of incremental rate and rate protection time period.

15. A non-transitory, computer-readable storage device comprising software that, when executed by a computer, causes the computer to:
receive as input information on a plurality of well work opportunities regarding a plurality of existing production rigs, each well work opportunity having a plurality of stages during its lifecycle;
determine a number of days each well work opportunity remains in a given stage;
for each stage, compute an average number of days a plurality of well work opportunities are in that particular stage; and
display a graph containing said computed averages.

16. The non-transitory, computer-readable storage device of claim 15 wherein the graph is a bar chart.

17. The non-transitory, computer-readable storage device of claim 10 wherein the software causes the computer to:
receive as input information on a plurality of well work opportunities regarding a plurality of existing production rigs;
track each of said well work opportunities through a plurality of stages and for said well work opportunities store and display history information of each well work opportunity, comparison information comparing a plurality of said well work opportunities, and a quantity of well work opportunities that are in each of the plurality of stages; and
compute and display an economic ranking for each well work opportunity.

18. The non-transitory, computer-readable storage device of claim 17 wherein said comparison information comprises economic rankings selected from an economic ranking table that cross references incremental rates to rate protection time periods.

19. The non-transitory, computer-readable storage device of claim 17 wherein the software causes the computer to display a list of multiple well work opportunities that are sorted in an order specified by a user.

20. A non-transitory, computer-readable storage device comprising software that, when executed by a computer, causes the computer to:
receive as input a user selection of a well work opportunity from among a plurality of well work opportunities, the selected well work opportunity being for an existing production rig;
for the selected well work opportunity, retrieve from a data storage device a history of all well work opportunities previously performed on said production rig, said history including for previously performed well work opportunity a date of said well work opportunity, a type of said well work opportunity and a result or status of said well work opportunity; and
display in tabular form on a display device, said retrieved history.

21. A non-transitory, computer-readable storage device comprising software that, when executed by a computer, causes the computer to:
receive as input a user filter selection of well work opportunities associated with production rigs, each well work opportunity having a plurality of stages in a lifecycle;
based on said user filter selection, select a subset of said well work opportunities;
retrieve from a data storage device information of said selected well work opportunities;
based on said information, compute an average number of days the selected well work opportunities remained in each stage; and
display a chart on a display device indicative of said computed averages.

22. The non-transitory, computer-readable storage device of claim 21 wherein the software also causes the computer to permit a user to filter well work opportunities into a subset of multiple well work opportunities, select a change applicable to all of the subset of well work opportunities, and apply the change to each of the subset of well work opportunities.
